(19) United States
(12) Patent Application Publication
(10) Pub. No.: US 2008/0143241 A1
(43) Pub. Date: Jun. 19, 2008

(54) DISCHARGE FIELD EMISSION DEVICE, AND LIGHT SOURCE APPARATUS AND DISPLAY APPARATUS APPLYING THE SAME

(75) Inventors: Jung-Yu Li, Taipei County (TW); Shih-Pu Chen, Hsinchu City (TW); Yi-Ping Lin, Changhua County (TW); Wei-Chih Lin, Taipei County (TW); Lian-Yi Cho, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/674,159

(22) Filed: Feb. 13, 2007

(30) Foreign Application Priority Data
Dec. 18, 2006 (TW) 95147427

(51) Int. Cl. H01J 1/62

(52) U.S. Cl. 313/496; 977/742

(57) ABSTRACT

A discharge field emission device including a cathode an anode, a conductive gas, and a phosphor is provided. The conductive gas is disposed between the cathode and the anode for inducing electrons from the cathode, wherein the conductive gas has a gas pressure between 10⁻¹ torr and 10⁻³ torr. In addition, the phosphor is disposed on the moving path of the electrons to react with the electrons and emit light. The discharge field emission device has the advantages of high luminescence efficiency and low cost. A light source apparatus and a display apparatus applying the discharge field emission device are also provided.

### CROSS-REFERENCE TO RELATED APPLICATION

This application claims the priority benefit of Taiwan application serial no. 95147427, filed Dec. 18, 2006. All disclosure of the Taiwan application is incorporated herein by reference.

### BACKGROUND OF THE INVENTION

1. Field of the Invention

The present invention relates to a luminescence device, more particularly, the present invention relates to a discharge field emission device and the application thereof.

2. Description of Related Art

Two main luminescence structures are applied in existing mass-produced light source apparatus or display apparatus, including:

1. Gas discharge light source which may be applied to a plasma panel or a gas discharge lamp, wherein gas that filled in a discharge chamber is dissociated under the effect of an electric field between a cathode and an anode, and due to gas conduction, transition occurs and ultra violet (UV) light is emitted when electrons collide with gas, and phosphor in the same discharge chamber absorbs UV light to emit visible light.

2. Field emission light source which may be applied to a carbon nanotube field emission display etc., wherein an ultra high vacuum environment is provided, and an electron emitter of nano carbon material on the cathode is produced for helping electrons to overcome the work function of the cathode to escape from the cathode due to the high aspect-ratio microstructure of the electron emitter. In addition, phosphor is disposed on the anode that is made of indium tin oxide (ITO), and electrons escape from carbon nanotube of the cathode under the effect of high electric field between the cathode and the anode. Thus, electrons may react with the phosphor on the anode in the vacuum environment to emit visible light.

However, there are disadvantages in both aforementioned luminescence structures. For example, considering the attenuation after UV irradiation, the material selection for gas discharge light source should meet a special requirement. Moreover, the luminescence mechanism of gas discharge requires two processes to emit a visible light, thus, the energy loss is considerable, and it will cost more if plasma needs to be generated during the process. In another aspect, electron emitter has to be evenly grown or disposed on the cathode of the field emission light source, however, the technology of mass-producing of such cathode structure is still immature, and the problems of poor electron emitter uniformity and poor production yield are still not resolved. Moreover, the space between the cathode and the anode of field emission light source requires precise control, and ultra high vacuum packaging is difficult to process, so the cost of production increases accordingly.

### SUMMARY OF THE INVENTION

The present invention relates to a discharge emission device that has good luminescence efficiency and is easy to be produced.

The present invention also relates to a light source apparatus using aforementioned discharge field emission device, configured to provide a good and uniform light source and has the advantages of low cost and good production yield.

The present invention also relates to a display apparatus using aforementioned discharge field emission devices as display pixels, configured to provide good display quality and reduce the cost and complexity of production.

To describe the present invention in detail, the present invention provides a discharge field emission device including a cathode, an anode, a conductive gas and a phosphor. The conductive gas is disposed between the cathode and the anode for inducing electrons from the cathode, wherein the conductive gas has a gas pressure between 10⁻¹ torr and 10⁻³ torr. In addition, the phosphor is disposed on the moving path of the electrons to react with the electrons and emit a light.

In addition, the present invention provides a light source apparatus including a plurality of aforementioned discharge field emission devices, configured to provide a light source. For example, these discharge field emission devices may be arranged as an array, and the light source provided is a planar light source.

Moreover, the present invention provides a display apparatus, wherein aforementioned discharge field emission devices are used as display pixels, and a display frame is formed by a plurality of display pixels, so as to display static or dynamic pictures.

As above described, in the present invention, thin conductive gas is used for inducing electrons from the cathode easily, so the problems that may occur when fabricating electron emitter on the cathode can be avoided. In addition, since the conductive gas used is thin, so the mean free path of electrons is wide, a lot of electrons react with the phosphor to emit light before they collide with gas. In other words, the discharge field emission device of present invention has high luminescence efficiency and good production yield, and is easy to be produced.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a comparing diagram illustrating the luminescence mechanisms of two conventional luminescence structures and the discharge field emission device of the present invention.

FIG. 2 illustrates the basic structure of a discharge field emission device of the present invention.

FIG. 3 illustrates a discharge field emission device according to another embodiment of the present invention.

FIGS. 4A-4C respectively illustrates a plurality of discharge field emission devices having inducing discharge structure.

FIGS. 5-7 respectively illustrates several luminescence structures with different forms applying discharge field emission devices of the present invention.

FIG. 8 illustrates a light source apparatus according to an embodiment of the present invention.

FIG. 9 illustrates a display apparatus according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

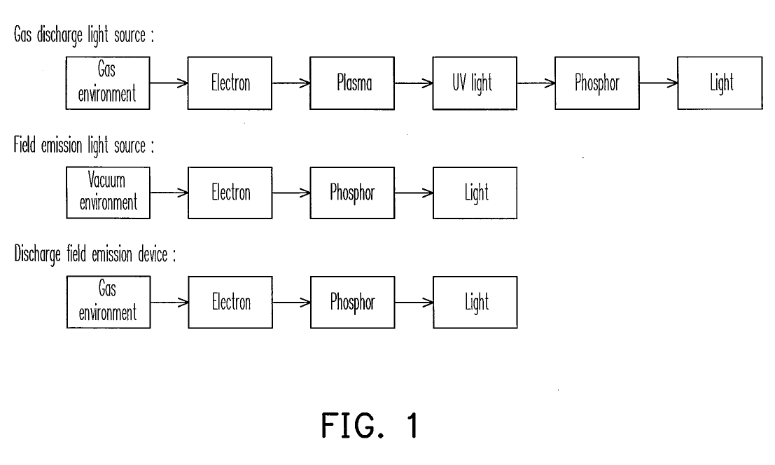

The discharge field emission device of the present invention has advantages of both the conventional gas discharge light source and the conventional field emission light source, and overcomes disadvantages of both aforementioned luminescence structures. FIG. 1 is a comparing diagram illustrating the luminescence mechanisms of the two aforementioned conventional luminescence structures and the discharge field emission device of the present invention. To be specific, in the conventional gas discharge light source, the gas that filled in discharge chamber is dissociated under the effect of the electric field between the cathode an the anode, and due to gas conduction, UV light is emitted when electrons collide with other gas molecules, and then the phosphor absorbs UV light to emit visible light. Moreover, the conventional field emission light source provide an ultra high vacuum environment helping electrons to overcome the work function of the cathode to escape from the cathode with the assistance of the high aspect-ratio microstructure of the electron emitter, and then, electrons escape from the electron emitter of the cathode under the effect of high electric field between the cathode and the anode, and react with the phosphor on the anode to emit visible light.

Different from aforementioned two conventional luminescence mechanisms, there is no need to form electron emitter in the discharge field emission device of the present invention; instead, electrons are induced easily from the cathode by using thin conductive gas and react directly with the phosphor to emit light.

Comparing with conventional gas discharge light source, the amount of the conductive gas filled in the discharge field emission device of the present invention is enough when meeting the requirement of inducing electrons from the cathode. Since the UV light is not adopted in the present invention to irradiate the phosphor for emitting light, attenuation of materials in the device due to the UV irradiation is eliminated. According to experiments and theory, the conductive gas is thin in discharge field emission device of the present invention, so the mean free path of electrons could reach to about 5 mm or above. In other words, most of the electrons react directly with the phosphor to emit visible light before they collide with molecules of the conductive gas. In addition, the discharge field emission device of the present invention doesn't require two processes for emitting light, so the luminescence efficiency is high, and the energy lost is low.

In another aspect, comparing with conventional field emission light source, the discharge field emission device of the present invention could induce electrons from the cathode by using the conductive gas, there's no need to form a microstructure of electron emitter on the cathode, so the producing cost is saved and the producing procedure is relatively simple. In addition, since thin conductive gas is filled in the discharge field emission device of the present invention, ultra high vacuum environment is unnecessary, this may avoid the difficult situations when processing ultra high vacuum packaging. Moreover, from experiments we know, with the assistance of conductive gas, the turn on voltage of discharge field emission device of the present invention could reduce to about 0.4V/μm, which is far more lower than the turn on voltage 1˜3V/μm of an ordinary field emission light source.

Moreover, according to known formula Child-Langmuir, when inputting the actual corresponding data of the discharge field emission device of the present invention, the result shows the distribution range of dark area of the cathode in the discharge field emission device of the present invention is between 10˜25 cm, it's far more larger than the distance between the cathode and the anode. In other words, there almost no gas of plasma state is generated between the cathode and the anode. So it can be determined that the discharge field emission device of the present invention does not use plasma mechanism for emitting light, but using the conductive gas to induce electrons from the cathode, and the electrons react directly with the phosphor to emit light.

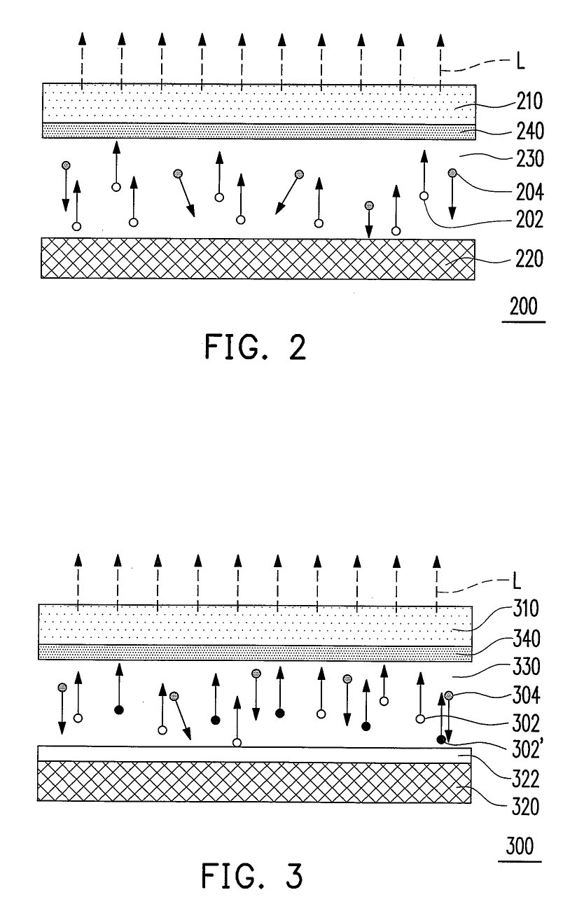

FIG. 2 illustrates the basic structure of a discharge field emission device of the present invention. Referring to FIG. 2, the discharge field emission device 200 comprises an anode 210, a cathode 220, a conductive gas 230 and a phosphor 240, wherein the conductive gas 230 is disposed between the anode 210 and the cathode 220, the conductive gas 230 generates adequate positive ions under the effect of the electric field to induce a plurality of electrons 202 from the cathode 220. It is noticeable that the gas pressure of the conductive gas 230 is between 10⁻¹ torr and 10⁻³ torr, preferably, between 2×10⁻² torr and 10⁻³ torr. In addition, the phosphor 240 is disposed on the moving path of the electrons 202 to react with the electrons 202 and emit light L.

In this embodiment, the phosphor 240 may be disposed on the surface of the anode 210. In addition, the anode 210 may be made of a transparent conductive oxide (TCO) for the light L to pass through and go outside of the discharge field emission device 200, wherein the transparent conductive oxide may be the common used material like indium tin oxide (ITO) or indium zinc oxide (IZO) etc. Certainly, in other embodiments, the anode 210 or the cathode 220 may be made of metal or other materials with good conductivity.

The conductive gas 230 applied in the present invention may be selected from the inert gases as He, Ne, Ar, Kr, Xe etc., or the gases with good conductivity when dissociated, as H₂, CO₂, etc. In addition, the discharge field emission device 200 may emit various kinds of light as visible light, infrared light or UV light etc. by choosing various types of the phosphor 240.

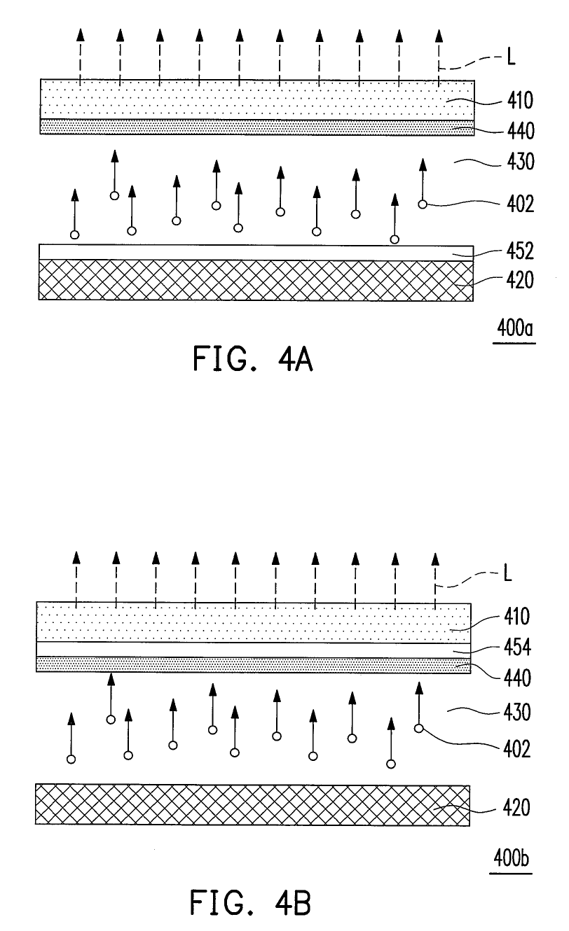

Beside the embodiment shown in FIG. 2, for improving luminescence efficiency, materials that are easy to generate electrons may be further disposed on the cathode to provide additional electron source. FIG. 3 illustrates a discharge field emission device according to another embodiment of the present invention, wherein a secondary electron source material layer 322 may be formed on the cathode 320 of the discharge field emission device 300. The material of the secondary electron source material layer 322 may be MgO, Tb₂O₃, La₂O₃ or CeO₂. Since the conductive gas 330 may generates free ions 304, and the positive ions 304 leave the anode 310 and move towards the cathode 320. Thus, when the ions 304 collide with the secondary electron source material layer 322 on the cathode 320, additional secondary electrons 302′ are generated. More electrons (includes original electrons 302 and secondary electrons 302′) react with phosphor 340 helps to increase luminescence efficiency. It is noticeable that the secondary electron source material layer 322 not only helps to generate the secondary electrons but also protects the cathode 320 from excessive bombardment of the ions 304.

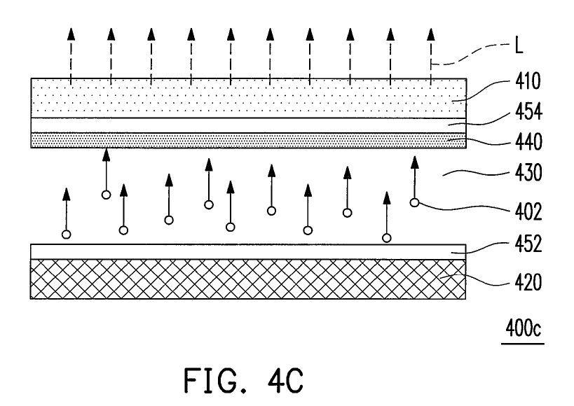

Moreover, the present invention may also choose on one of the anode and the cathode, or on both of them to form a structure similar to the electron emitter on the ordinary field emission light source. By this way, the working voltage on electrodes is reduced, and electrons are much easier to be generated. FIGS. 4A-4C respectively illustrates various discharge field emission devices having inducing discharge structure, wherein the same reference number indicate the similar parts, and the repeated description thereof will be omitted.

Referring to FIG. 4A, the discharge field emission device 400a has an inducing discharge structure 452 on the cathode 420, it is a microstructure that may be made of metal, carbon nanotube, carbo nanowall, carbon nanoporous, columnar ZnO, or ZnO etc. In addition, the conductive gas 430 is disposed between the anode 410 and the cathode 420, and the phosphor 440 is disposed on surface of the anode 410. The working voltage between the anode 410 and the cathode 420 may be reduced due to the inducing discharge structure 452, and the electrons 402 are much easier to be generated. The electrons 402 react with the phosphor 440 to emit light L.

The discharge field emission device 400b illustrated in FIG. 4B is similar to that in FIG. 4A, the obvious difference is that an inducing discharge structure 454 is disposed on the anode 410 instead, and this inducing discharge structure 454 is a microstructure that may be made of aforementioned materials as metal, carbo nanotube, carbon nanowall, carbon nanoporous, columnar ZnO, or ZnO etc. In addition, the phosphor 440 is disposed on the inducing discharge structure 454.

FIG. 4C illustrates a discharge field emission device 400c having both inducing discharge structures 454 and 452, wherein the inducing discharge structure 454 is disposed on the anode 410, the phosphor 440 is disposed on the inducing discharge structure 454, and the inducing discharge structure 452 is disposed on the cathode 420. The conductive gas 430 is disposed between the anode 410 and the cathode 420.

The aforementioned discharge field emission devices having inducing discharge structure 452 and/or 454 as 400a, 400b, or 400c may be further integrated as the design of the secondary electron source material layer 322 shown in FIG. 3 to form a secondary electron source material layer on the cathode 420. If an inducing discharge structure 454 is already formed on the cathode 420, the secondary electron source material layer may cover the inducing discharge structure 454. Thus, not only the working voltage between the anode 410 and the cathode 420 is reduced to benefit the generation of the electrons 402, but also the luminescence efficiency is improved due to the increment of the amount of the electrons 402 by applying the secondary electron source material layer.

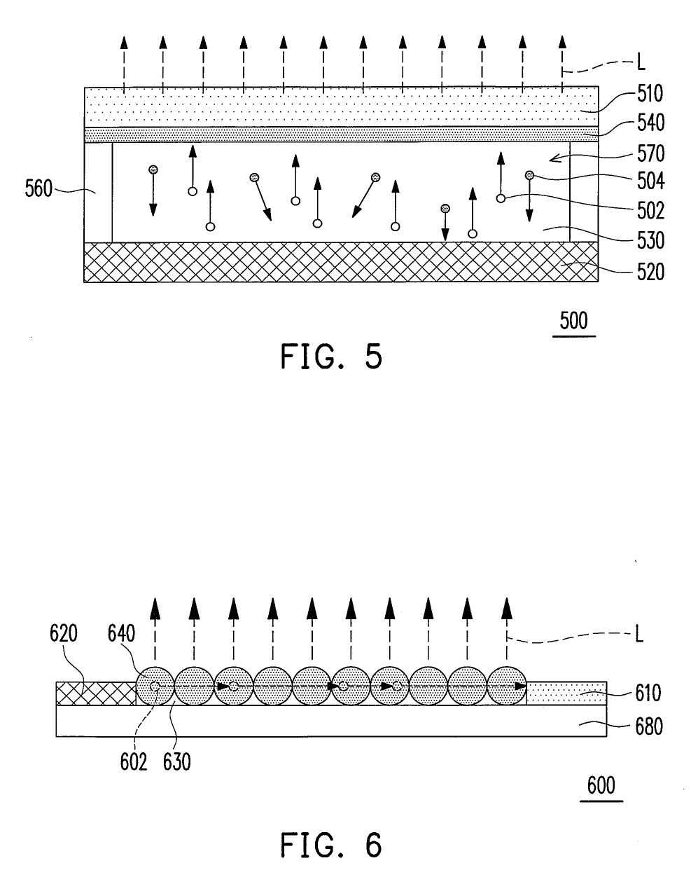

The discharge field emission devices that the present invention provided may have different forms as a luminescence structure. FIGS. 5-7 respectively illustrates several luminescence structures with different forms applying discharge field emission devices of the present invention.

First, FIG. 5 illustrates a luminescence structure 500 of parallel type, comprising an anode 510, a cathode 520, a conductive gas 530, a phosphor 540 and a spacer 560. The anode 510 is parallel to the cathode 520, and the phosphor 540 is disposed on a surface of the anode 510. The spacer 560 is disposed to the periphery of the anode 510 and the cathode 520 to form a confined space 570. The conductive gas 530 is filled in the confined space 570, and under the effect of the electric field between the anode 510 and the cathode 520, adequate positive ions 504 are generated to induce the cathode 520 emitting a plurality of electrons 502. In addition, electrons 502 move towards the anode 510 under the effect of the electric field between the anode 510 and the cathode 520, and react with the phosphor 540 to emit light L.

The gas pressure of the conductive gas 530 of the present invention may be between 10⁻¹ torr and 10⁻³ torr as aforementioned, preferably, between 2×10⁻² torr and 10⁻³ torr. In addition, the anode 510 may be made of common used transparent conductive oxide as ITO or IZO for the light L to pass through, and the cathode 520 may be made of metal or other materials with good conductivity. In addition, the conductive gas 530 used in the present invention may be selected from the inert gases as He, Ne, Ar, Kr, Xe etc., or the gases with good conductivity when dissociated, as H₂ or CO₂ etc. Moreover, the luminescence structure 500 may emit various kinds of light as visible light, infrared light or UV light etc. by choosing various types of the phosphor 540.

FIG. 6 illustrates another luminescence structure 600 of in-plane emission type, wherein the anode 610, the cathode 620 and the phosphor 640 are disposed on a substrate 680, this substrate 680 may be a glass substrate, and the anode 610 and the cathode 620 may be made of metal. The phosphor 640 is disposed between the anode 610 and the cathode 620, and the electrons 602 induced by the conductive gas 630 may pass through the phosphor 640 and emit light L. Please refer to the aforementioned embodiment for the description of other components, the repetition here will be omitted.

FIG. 7 illustrates another luminescence structure 700 of tubular type, where in the anode 710 may be a hollow tube, and the cathode 720 may be in a rod shape and is inserted into the hollow tube of the anode 710. The conductive gas 730 is filled in the confined space 770, and under the effect of the electric field between the anode 710 and the cathode 720, adequate positive ions 704 are generated to induce the cathode 720 emitting a plurality of electrons 702. The anode 710 may be made of common used transparent conductive oxide as ITO or IZO, and the phosphor 740 is disposed on the inner wall of the hollow tube of the anode 710. Electrons 702 move towards the anode 710 under the effect of the electric field between the anode 710 and the cathode 720, and react with the phosphor 740 to emit light L passing through the anode 710. Please refer to the aforementioned embodiment for the description of other components, the repetition here will be omitted.

It is noticeable that the luminescence structures shown in FIGS. 5-7 are for the purpose of describing particular embodiments only and is not intended to be limiting the forms of luminescence structures of the invention. In other embodiments, for satisfying various requirements, it may further combine the aforementioned luminescence structures with the secondary electron source material layer 322 shown in FIG. 3 or with the inducing discharge structures 452 and 454 shown in FIGS. 4A-4C.

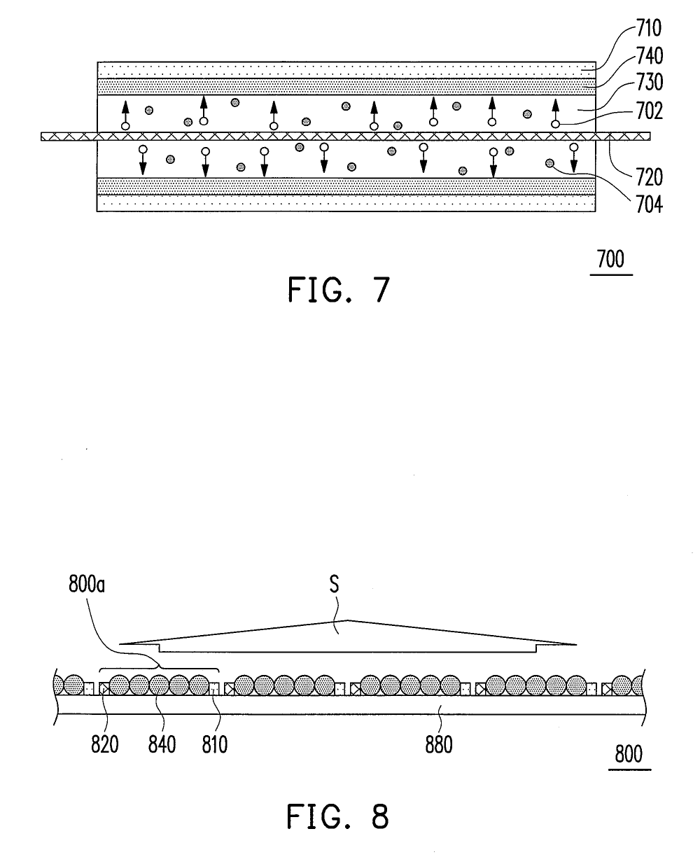

The discharge field emission device of the present invention may further be applied to produce a light source apparatus for providing a light source, the light source apparatus may be comprised of any discharge field emission device of the embodiments aforementioned. FIG. 8 illustrates a light source apparatus according to an embodiment of the present invention. Referring to FIG. 8, the light source apparatus includes a plurality of discharge field emission devices 800a arranged as an array to provide a planar light source S. The discharge field emission device 800a used in this embodiment may be any discharge field emission device of the aforementioned embodiments. For example, the light source apparatus 800 may uses the design of luminescence structure 600 shown in FIG. 6 to fabricate a plurality sets of the anode 810, the cathode 820 and the phosphor 840 on a substrate 880, so as to form a large-scale light source apparatus.

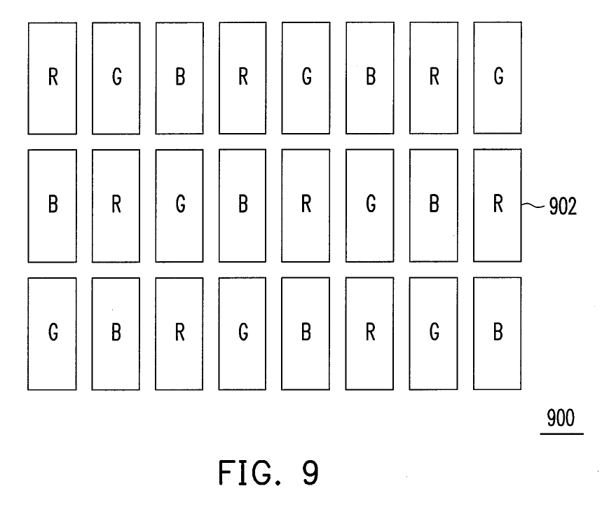

Certainly, the various kinds of discharge field emission device aforementioned may also be applied on a display apparatus. FIG. 9 illustrates a display apparatus according to an embodiment of the present invention. Referring to FIG. 9, each display pixel 902 of the display apparatus 900 is formed of a discharge field emission device, and a display frame is formed of a plurality of display pixels 902 for displaying static or dynamic pictures. Since the discharge field emission device is applied here as a display pixel 902, the phosphors capable of emitting red light, green light and blue light may be used in the respective discharge field emission devices to form red display pixel R, green display pixel G and blue display pixel B, thus, full colour display effect is achieved accordingly.

In overview, the discharge field emission device, and the light source apparatus and the display apparatus applying the same in the present invention have such advantages as saving energy, high luminescence efficiency, short response time, easy to produce and environmental friendly (non-Hg), so as to provide the market another choice of the light source apparatus or the display apparatus. Comparing with the conventional luminescence structures, the discharge field emission device of the present invention is simple in structure, and may work properly when the cathode is just a planar structure, the secondary electron source material layer or inducing discharge structure is optional component, not necessary one. In addition, ultra high vacuum environment is unnecessary in producing the discharge field emission device of the present invention, so the producing procedure is simplified and benefits for mass production accordingly.

In another aspect, the cathode of the discharge field emission device of the present invention may be metal, so the reflectivity, brightness, and luminescence efficiency may be improved accordingly. In addition, the wavelength of the light which the discharge field emission device sending out depends on the type of the phosphor, so the light source with various range of wavelength may be designed according to various uses of the light source apparatus or the display apparatus. Moreover, the discharge field emission device of the present invention may be designed as a planar light source, linear light source or spot light source to meet the requirement of various uses of the display apparatus and the light source apparatus, such as the backlight module or the lighting fixtures etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A discharge field emission device, comprising:
a cathode;
an anode;
a conductive gas, disposed between the cathode and the anode, configured to induce a plurality of electrons from the cathode, wherein the gas pressure of the conductive gas is between 10−1 torr and 10−3 torr; and
a phosphor, disposed on the moving path of the electrons to react with the electrons and emit light.

2. The discharge field emission device as claimed in claim 1, wherein the gas pressure of the conductive gas is between 2×10−2 torr and 10−3 torr.

3. The discharge field emission device as claimed in claim 1, wherein the phosphor is disposed on a surface of the anode.

4. The discharge field emission device as claimed in claim 1 further comprising a substrate, configured to carry the anode, the cathode and the phosphor, wherein the phosphor is disposed between the anode and the cathode.

5. The discharge field emission device as claimed in claim 1, wherein the anode forms a hollow tube, and the cathode is in a rod shape and is inserted into the hollow tube, and the phosphor is disposed on the inner wall of the hollow tube.

6. The discharge field emission device as claimed in claim 1, wherein the anode is made of a transparent conductive oxide.

7. The discharge field emission device as claimed in claim 6, wherein the transparent conductive oxide comprises indium tin oxide (ITO) or indium zinc oxide (IZO).

8. The discharge field emission device as claimed in claim 1, wherein material of the anode or the cathode comprises metal.

9. The discharge field emission device as claimed in claim 1 further comprising an inducing discharge structure, disposed on at least one of the anode and the cathode.

10. The discharge field emission device as claimed in claim 9, wherein the inducing discharge structure comprises metal, carbon nanotube, carbon nanowall, carbon nanoporous, columnar ZnO, or ZnO.

11. The discharge field emission device as claimed in claim 1 further comprising a secondary electron source material layer, disposed on the cathode.

12. The discharge field emission device as claimed in claim 11, wherein material of the secondary electron source material layer comprises MgO, Tb₂O₃, La₂O₃ or CeO₂.

13. The discharge field emission device as claimed in claim 1, wherein the conductive gas comprises inert gas, H₂ or CO₂.

14. The discharge field emission device as claimed in claim 1, wherein the light comprises visible light, infrared light or UV light.

15. A light source apparatus, comprising a plurality of discharge field emission devices, wherein each discharge field emission device comprises:
a cathode;
an anode;
a conductive gas, disposed between the cathode and the anode, configured to induce a plurality of electrons from the cathode, wherein the gas pressure of the conductive gas is between 10−1 torr and 10−3 torr; and
a phosphor, disposed on the moving path of the electrons to react with the electrons and emit light.

16. The light source apparatus as claimed in claim 15, wherein the gas pressure of the conductive gas is between 2×10−2 torr and 10−3 torr.

17. The light source apparatus as claimed in claim 15, wherein the phosphor of each discharge field emission device is disposed on a surface of the anode.

18. The light source apparatus as claimed in claim 15 further comprising a substrate, configured to carry the anode, the cathode and the phosphor of each discharge field emission device, wherein the phosphor is disposed between the anode and the cathode.

19. The light source apparatus as claimed in claim 15, wherein the anode of each discharge field emission device forms a hollow tube, and the cathode is in a rod shape and is inserted into the hollow tube, and the phosphor is disposed on the inner wall of the hollow tube.

20. The light source apparatus as claimed in claim 15, wherein the anode of each discharge field emission device is made of a transparent conductive oxide.

21. The light source apparatus as claimed in claim 20, wherein the transparent conductive oxide comprises ITO or IZO.

22. The light source apparatus as claimed in claim 15, wherein material of the anode or the cathode of each discharge field emission device comprises metal.

23. The light source apparatus as claimed in claim 15, wherein each discharge field emission device further comprises an inducing discharge structure, disposed on at least one of the anode and the cathode.

24. The light source apparatus as claimed in claim 23, wherein the inducing discharge structure of each discharge field emission device comprises metal, carbon nanotube, carbon nanowall, carbon nanoporous, columnar ZnO, or ZnO.

25. The light source apparatus as claimed in claim 15, wherein each discharge field emission device further comprising a secondary electron source material layer, disposed on the cathode.

26. The light source apparatus as claimed in claim 25, wherein material of the secondary electron source material layer of each discharge field emission device comprises MgO, Tb₂O₃, La₂O₃ or CeO₂.

27. The light source apparatus as claimed in claim 15, wherein the conductive gas of each discharge field emission device comprises inert gas, H₂ or CO₂.

28. The light source apparatus as claimed in claim 15, wherein the light of each discharge field emission device comprises visible light, infrared light or UV light.

29. The light source apparatus as claimed in claim 15, wherein the discharge field emission devices are arranged as an array.

30. The light source apparatus as claimed in claim 15, wherein the lights emitted from the discharge field emission devices form a planar light source.

31. A display apparatus, having a plurality of display pixels arranged as an array, wherein each display pixel comprises a discharge field emission device, the discharge field emission device comprising:
a cathode;
an anode;
a conductive gas, disposed between the cathode and the anode, configured to induce a plurality of electrons from the cathode, wherein the gas pressure of the conductive gas is between 10−1 torr and 10−3 torr; and
a phosphor, disposed on the moving path of the electrons to react with the electrons and emit light.

32. The display apparatus as claimed in claim 31, wherein the gas pressure of the conductive gas is between 2×10−2 torr and 10−3 torr.

33. The display apparatus as claimed in claim 31, wherein the phosphor of each discharge field emission device is disposed on a surface of the anode.

34. The display apparatus as claimed in claim 31 further comprising a substrate, configured to carry the anode, the cathode and the phosphor of each discharge field emission device, wherein the phosphor is disposed between the anode and the cathode.

35. The display apparatus as claimed in claim 31, wherein the anode of each discharge field emission device forms a hollow tube, and the cathode is in a rod shape and is inserted into the hollow tube, and the phosphor is disposed on the inner wall of the hollow tube.

36. The display apparatus as claimed in claim 31, wherein the anode of each discharge field emission device is made of a transparent conductive oxide.

37. The display apparatus as claimed in claim 36, wherein the transparent conductive oxide comprises ITO or IZO.

38. The display apparatus as claimed in claim 31, wherein material of the anode or the cathode of each discharge field emission device comprises metal.

39. The display apparatus as claimed in claim 31, wherein each discharge field emission device further comprising an inducing discharge structure, disposed on at least one of the anode and the cathode.

40. The display apparatus as claimed in claim 39, wherein the inducing discharge structure of each discharge field emission device comprises metal, carbon nanotube, carbon nanowall, carbon nanoporous, columnar ZnO, or ZnO.

41. The display apparatus as claimed in claim 31, wherein each discharge field emission device further comprising a secondary electron source material layer, disposed on the cathode.

42. The display apparatus as claimed in claim 41, wherein material of the secondary electron source material layer of each discharge field emission device comprises MgO, Tb₂O₃, La₂O₃ or CeO₂.

43. The display apparatus as claimed in claim 31, wherein the conductive gas of each discharge field emission device comprises inert gas, H₂ or CO₂.

44. The display apparatus as claimed in claim 31, wherein the light of each discharge field emission device comprises red light, green light or blue light.
